(19) United States
(12) Patent Application Publication
(10) Pub. No.: US 2021/0080973 A1
(43) Pub. Date: Mar. 18, 2021

(54) METHOD FOR DETERMINING AT LEAST ONE REFERENCE VALUE OF A MAINTENANCE PARAMETER OF A VEHICLE, AND CORRESPONDING SYSTEM

(71) Applicant: PSA AUTOMOBILES SA, Poissy (FR)

(72) Inventor: Youssef CHIKH, PUTEAUX (FR)

(21) Appl. No.: 17/044,300

(22) PCT Filed: Mar. 20, 2019
(86) PCT No.: PCT/FR2019/050625

§ 371 Date: Sep. 30, 2020

(30) Foreign Application Priority Data
Apr. 4, 2018 (FR) 1852917

(51) Int. Cl. G05D 1/02; G06Q 10/00; G07C 5/00; G07C 5/08; G01C 21/20; H04L 29/08

(52) U.S. Cl. CPC G05D 1/0285; G06Q 10/20; H04L 67/12; G07C 5/0808; G01C 21/20; G07C 5/006

(57) ABSTRACT

The method comprises the steps of: a) retrieving a numeric value from a filling parameter, a location parameter and an alphanumeric code, and b) calculating a reference value of a maintenance parameter of a vehicle using the filling parameter, the location parameter and the alphanumeric code.

### CROSS-REFERENCE TO RELATED APPLICATIONS

This application is the US National Stage under 35 USC § 371 of International Application No. PCT/FR2019/050625, filed 20 Mar. 2019 which claims priority to French Application No. 1852917 filed 4 Apr. 2018, both of which are incorporated herein by reference.

### BACKGROUND

The present invention relates to a method for determining at least one reference value of a maintenance parameter of a vehicle.

The invention applies, for example, to motor vehicles. In 2017, there were more than fifteen million new cars registered in the European Union.

It is known that most motor vehicles are provided with a fuel tank that must be refueled. Conventionally, the process of refueling a vehicle's tank begins with an initial step that involves taking the vehicle to a refueling device. Already at this step, it is clear that the current refueling process is not ideal. In effect, the fact of taking a vehicle to a refueling device involves a risk of accident, a risk that is in fact inherent in any movement. Thus, if this simple initial step of the refueling process is scaled up countrywide, for example by counting all of the refueling journeys over a given period of time, such journeys being partly linked to refueling needs, it seems reasonable to think that the number of accidents linked to these refueling journeys can have a non-zero value. It also seems natural to conclude that there is nothing to prevent the value of the number of accidents linked to refueling journeys from sometimes reaching significant values, despite the very tight territorial grid created by the fuel suppliers. Furthermore, constraints linked to the existing refueling processes represent another disadvantage from an organizational point of view. In fact, a journey to the closest refueling point, even if very short, can obviously not be made without spending time. By thus wasting time, the existing vehicle refueling process, particularly due to the obligation of performing the initial step thereof, negatively affects the organizational flexibility of the user who performs it. Lastly, on an environmental level, as no movement can take place without consuming fuel, there is no denying that a negative footprint is caused by the detours imposed by the existing refueling processes.

Moreover, the operators of vehicle fleets have already set up computerized systems to meet a need to regularly check certain vehicle operating parameters. However, use of computers cannot be achieved without consuming energy and, as a corollary, any computer system has an environmental impact. Also, if we wish to optimize a refueling process by means of a control system based at least partially on a computer system, a balance must be struck by weighing the improvement achieved in terms of the environmental impact by computerized control against the negative footprint created by providing and using computerized control means.

### SUMMARY

One object is to provide a method enabling the adaptation of a refueling process of a vehicle that is safer with regard to accident risk, more flexible from an organizational point of view and enables an improvement from an environmental point of view. Another object is to provide a method that increases the safety of the refueling process, capable in particular of distinguishing different types of fuel. Another object is to provide a method that processes targeted information in real time so as to reduce the fuel consumption of a vehicle. Another object is to provide a method that fully automates the vehicle refueling process so that it can be performed with no need for any intervention by the user.

To this end, disclosed is a method for determining by means of a computerized system at least one reference value of at least one maintenance parameter of a vehicle, the method comprising the steps of:
a) retrieving a numeric value from a filling parameter, a location parameter, and an alphanumeric code, and
b) calculating the reference value using the filling parameter, the location parameter and the alphanumeric code.

According to a variation, step b) can comprise a step of using the alphanumeric code to determine a value of an operating parameter of the vehicle. With this variation, the method can distinguish the vehicles from the point of view of the fuel used.

According to another variation, step b) can comprise a step of using the location parameter to select at least one geographic coordinate. This variation allows the method to minimize fuel consumption by determining optimized meeting points that minimize the distances traveled.

According to another variation, step b) can comprise a step of determining a value of a provisional consumption parameter and, according to another variation, a step of determining a provisional journey, the journey being identified by at least one departure geographic coordinate and one arrival geographic coordinate. With these variations, the method can distinguish the vehicles from the point of view of an operating profile.

According to another variation, the method can comprise a step comprising:
c1) transmitting an instruction to a control system of a mobile refueling system, the instruction being determined on the basis of the filling parameter, the location parameter and the alphanumeric code, and the instruction comprising at least one geographic coordinate.

With this variation, the method optimizes a refueling process to the point that it can be performed with no need for any intervention by the user.

According to another variation, the method can comprise a step comprising:
c2) generating, on the basis of the reference value, the transmission of an email and/or SMS.

With this variation, the method enables better security of a refueling process.

According to another variation, step a) may comprise the sub-steps of:
a0) receiving the numeric value generated during detection of an electrical signal provided by a sensor arranged in a tank of the vehicle,
a1) receiving the generated location parameter by interrogating a vehicle location device via an interface, and
a2) receiving the generated alphanumeric code by interrogating a data storage medium arranged in the vehicle.

With this variation, the method is capable of handling a plurality of vehicles.

Also disclosed is a system for determining at least one reference value of at least one maintenance parameter of a vehicle, the system comprising means to perform steps of a method as described above.

According to one variation, the system may comprise at least one computer and storage means wherein at least one program for executing the steps of a method as described above are stored.

Further, a computer program comprising instructions for executing the steps of a method as described above is disclosed.

Lastly, disclosed is a medium that can be used in a computer and on which is recorded a program as described above.

### DESCRIPTION OF THE FIGURES

A better understanding of the invention will emerge from the following description, given purely by way of example, with reference to the accompanying drawings, in which:

FIG. 1 is a block diagram of a system for determining values of maintenance parameters,

FIG. 2 is a flowchart showing certain steps of the method performed by the system in FIG. 1,

FIG. 3 is a flowchart showing certain steps of the method performed by the system in FIG. 1,

FIG. 4 is a flowchart showing certain steps of the method performed by the system in FIG. 1, and

FIG. 5 is a flowchart showing certain steps of the method performed by the system in FIG. 1.

### DETAILED DESCRIPTION

A determination system 100 for the method is shown in FIG. 1. This system comprises an information processing unit 101 comprising one or more processors, data storage means 102, input and output means 103 and, optionally, display means 104. According to other embodiments, the system 100 comprises one or more computers, one or more servers, one or more supercomputers and/or any combination comprising one of these computer systems. According to another embodiment, the system 100 comprises an interface with a private or public communication network, for example the internet, in order to send and receive data. Advantageously, the system 100 is thus able to communicate by exchanging data in real time with a vehicle monitoring system, the latter regularly receiving data from at least one telematics box in at least one vehicle. Alternatively, the system 100 communicates directly with a telematics box of a vehicle. According to another embodiment, the system 100 also comprises dedicated interfaces to generate and issue instructions to a control system of a mobile refueling device (not shown).

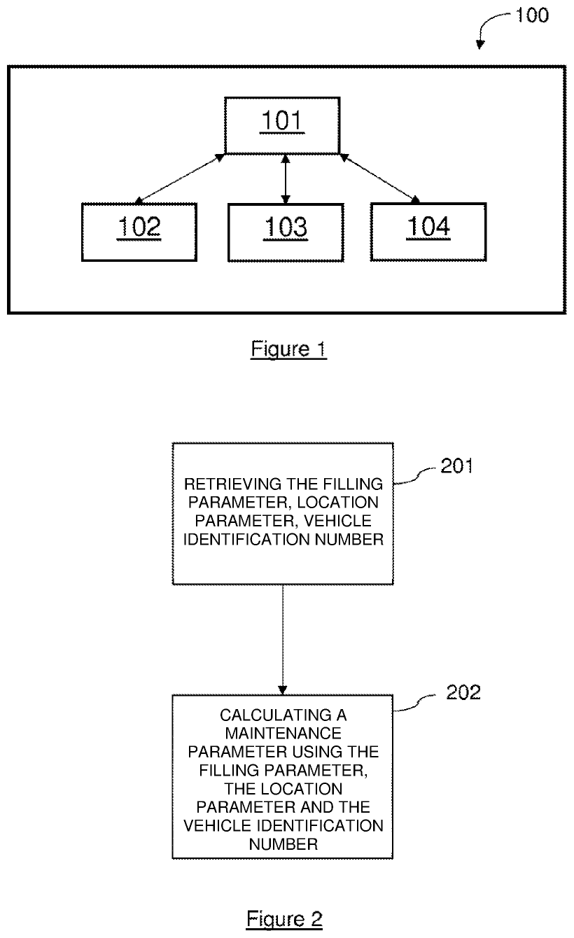

The determination method is shown in FIG. 2. As stated above, the method aims to optimize a refueling method of a vehicle.

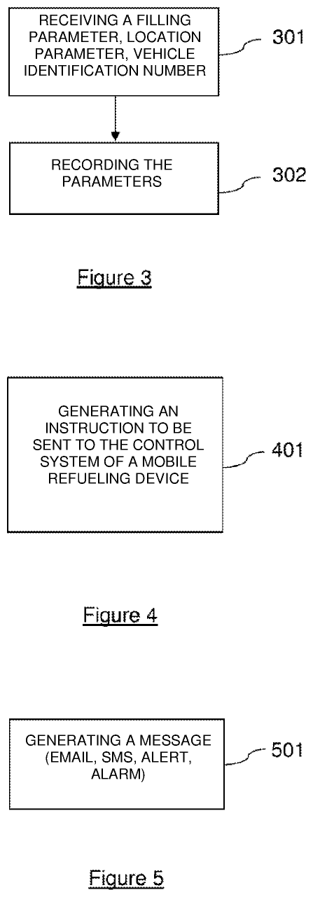

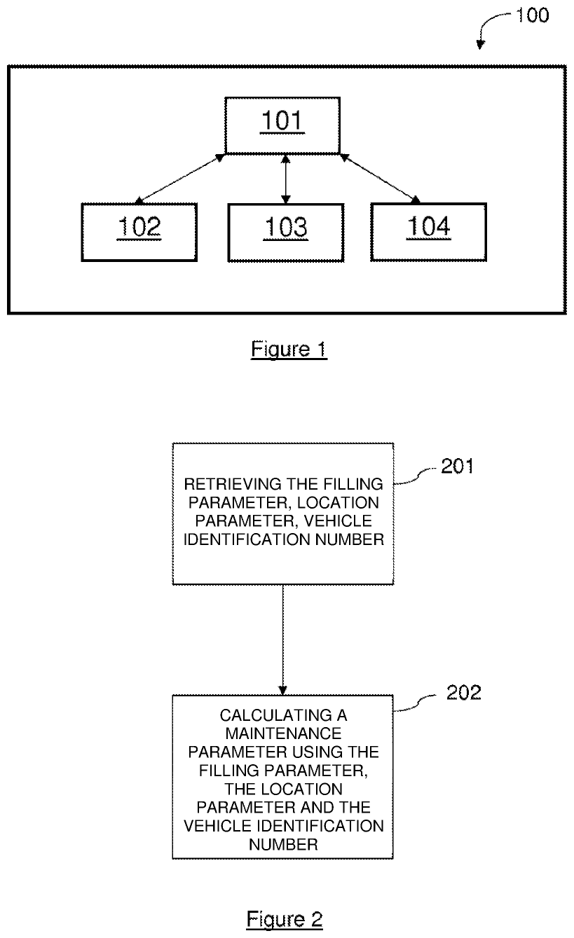

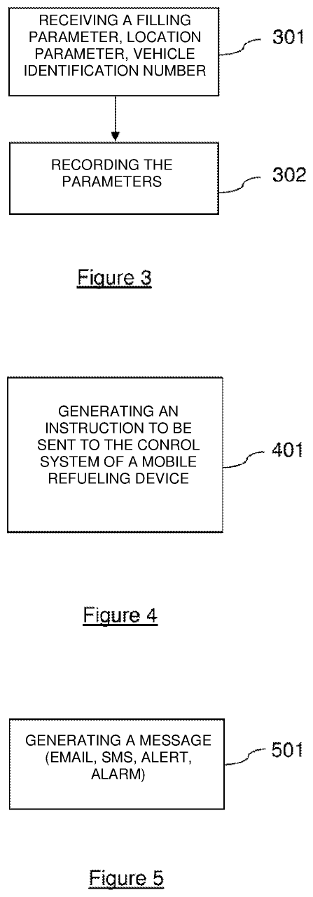

A first step illustrated by block 201 comprises retrieving from the data storage means 102 a numeric value of a filling parameter, a value of a location parameter and an alphanumeric code. Preferably, a telematics box arranged in the vehicle has been used beforehand to generate the numeric value on the basis of an electrical signal emitted by a sensor arranged in the vehicle's tank. Also beforehand, the vehicle's telematics box, having its own data processing and storage means, has been used to generate the location parameter via its interface functionalities with a vehicle location device. In parallel, the telematics box of the vehicle has also been used to generate the alphanumeric code, by proceeding, for example, to retrieve this code from a secure data storage medium included in the telematics box or arranged independently in the vehicle. Lastly, as shown in FIG. 3, the telematics box has also been used to send these processing parameters so that they have been received at the communication interface of the system 100 during a step 301 and, during a step 302, finally recorded in the data storage means 102.

Thus, the filling parameter preferably corresponds to a volume equivalent to the fill level of a tank of a vehicle or a volume equivalent to the difference between a fill level and a reserve level. Similarly, the location parameter preferably comprises at least one geographic coordinate to identify a longitude and/or latitude value so as to precisely identify the geographic position of the vehicle. Lastly, the alphanumeric code preferably corresponds to the unique identification code of a motor vehicle, usually called the VIN (Vehicle Identification Number).

A deliberate choice is therefore made with respect to the nature of the processing parameters of the method, particularly due to their deliberately limited number. This choice is justified by finding a balance between, on the one hand, minimizing the energy cost that this choice involves from the computing point of view and, on the other, the relevance of the information obtained in relation to a refueling process. By precisely selecting these three particular parameters, the method is capable of achieving the desired balance.

In fact, a second step of the method shown by block 202 and performed by the means 101 then comprises jointly using the filling parameter, the location parameter and the alphanumeric code to calculate a reference value of at least one first maintenance parameter. Preferably, the maintenance parameter identifies by its reference value the need to refuel a vehicle. For example, a numeric value corresponding to the zero value might be attributed in order to identify a lack of need to refuel, whereas a non-zero numeric value might be attributed in order to identify the existence of a need to refuel. Alternatively or cumulatively, the reference value of the maintenance parameter indicates a remaining duration or a remaining number of kilometers to be traveled before refueling.

Also, by being capable of determining whether a need to refuel exists, the steps described above enable a refueling process that achieves the above-mentioned aim to be adapted. In fact, the process of refueling a vehicle can be optimized once the user is no longer the sole possessor of the knowledge of a need to refuel. Preferably, step 202 also comprises several steps that enable the capabilities of the method to be further improved so that an even more optimized refueling process can be adapted.

According to a particular embodiment, step 202 comprises a step that comprises using the alphanumeric code to determine a value of a vehicle operating parameter. Such an operating parameter can correspond to a maximum tank-filling capacity, an appropriate type of fuel, a tank reserve volume, etc. For example, the VIN is used to determine whether the appropriate fuel for a particular vehicle is diesel. Advantageously, the method is thus capable of distinguishing vehicles with respect to the fuel used.

According to another particular embodiment, step 202 comprises a step that comprises using the location parameter to select at least one geographic coordinate. Such a coordinate preferably corresponds to a meeting place where a refueling process will be performed by means of a mobile refueling device. Advantageously, the geographic coordinate is selected so as to minimize a travel distance of the vehicle. A geographic coordinate of a meeting place can alternatively be selected in order to minimize both the journey of the vehicle and that traveled by a mobile refueling device.

According to another particular embodiment, step 202 comprises a step that comprises determining a provisional consumption or provisional journey. Based on the processing parameters received, the method retrieves a consumption history and/or a journey history for the vehicle in question. Based on this information, other reference values of other maintenance parameters are determined. Thus, another maintenance parameter corresponds to a frequency of refueling and is determined when it is considered, according to a simulation of a provisional journey carried out on the basis of a history of journeys, that a vehicle in question makes a great many energy-intensive journeys and must therefore be refueled according to a specific refueling frequency. Similarly, another maintenance parameter corresponds to a consumption profile and is attributed on the basis of a simulation of a provisional consumption made with respect to a consumption history. Consequently, the method is capable of distinguishing vehicles from the point of view of their operating profiles, particularly in terms of consumption of habitual usual journeys. Indirectly, this functionality permitted by the method further optimizes the refueling process by making it adaptive it in real time.

According to another particular embodiment, the method comprises a step shown by block 401 in FIG. 4, which comprises using the processing parameters of the reference value to send an instruction to a control system of a mobile refueling device. Preferably, such an instruction comprises the geographic coordinate of a meeting place to which the mobile refueling device must go in order to refuel a vehicle. Alternatively or cumulatively, the instruction comprises information identifying an appropriate type of fuel and time indication data. With this step, the method optimizes a refueling process so that the latter can be performed with no need for any intervention by the user. This is in fact the case when considering the system 100 to be active in an environment where the means of securing access are available so that a mobile refueling device can, on its own, refuel a vehicle.

According to another particular embodiment, the method comprises a step shown by block 501 in FIG. 5 that comprises generating an alert instruction, for example by issuing and transmitting an email or SMS. With this step, the method provides information to a user, maintenance service or any other entity involved in a refueling process. Here too, the method optimizes the refueling process enabling improved security by providing a functionality combining continuous checking of the refueling parameters with the alert means. The method then implements refueling processes wherein, through these alert means, an interaction functionality is introduced so that a user can interact directly with a control system of a mobile refueling device. Alternatively or cumulatively, the alert means are used in connection with the access security means as described above in order to facilitate better security of the refueling process.

The above principles can apply to all types of motor vehicles, particularly vehicles that use petroleum or other fuels to operate.

The method is limited neither to the combinations of steps nor to the embodiments described above; rather, certain steps described as belonging to certain embodiments can be combined with steps described as belonging to other embodiments in order thus to create other embodiments that are not described above but that fall within the scope of protection defined by the claims.

1. A. method for determining by means of a computer system at least one reference value of at least one maintenance parameter of a vehicle, the method comprising the steps of:
a) retrieving a numeric value from a filling parameter, a location parameter and an alphanumeric code, and
b) calculating the at least one reference value using the filling parameter, the location parameter and the alphanumeric code.

2. The method according to claim 1, wherein step b) comprises a step of using the alphanumeric code to determine a value of an operating parameter of the vehicle.

3. The method according to claim 1, wherein step b) comprises a step of using the location parameter to select at least one geographic coordinate.

4. The method according to claim 1, wherein step b) comprises a step of determining a value of a provisional consumption parameter.

5. The method according to claim 1, wherein step b) comprises a step of determining a provisional journey, said journey being identified by at least one departure geographic coordinate and one arrival geographic coordinate.

6. The method according to claim 1, wherein said method comprises a step comprising:
c1) transmitting an instruction to a control system of a mobile refueling device, said instruction being determined on the basis of the filling parameter, the location parameter and the alphanumeric code, said instruction comprising at least one geographic coordinate.

7. The method according to claim 1, wherein said method comprises a step comprising:
c2) generating, on the basis of the reference value, the transmission of and transmitting an email and/or SMS.

8. The method according to claim 1 wherein step a) comprises the sub-steps of:
a0) receiving the numeric value generated during detection of an electrical signal provided by a sensor arranged in a tank of the vehicle,
a1) receiving the generated location parameter by interrogating a vehicle location device via an interface, and
a2) receiving the generated alphanumeric code by interrogating a data storage medium arranged in the vehicle.

9. A computer system for determining at least one reference value of at least one maintenance parameter of a vehicle, wherein said system comprises means for performing the steps of the method of claim 1.

10. The system according to claim 9, wherein said system comprises at least one computer and storage means in which are stored at least one program for executing the steps of the method of determination implemented by the system.
